(19) United States
(12) Patent Application Publication
(10) Pub. No.: US 2026/0365223 A1
(43) Pub. Date: Nov. 19, 2026

(54) STEERING COLUMN FOR VEHICLE

(71) Applicant: HL MANDO CORPORATION, Gyeonggi-do (KR)

(72) Inventor: Hyun KIM, Gyeonggi-do (KR)

(21) Appl. No.: 19/409,630

(22) Filed: Dec. 4, 2025

(30) Foreign Application Priority Data
May 16, 2025 (KR) 10-2025-0064003

(51) Int. Cl. B62D 1/18

(52) U.S. Cl. CPC B62D 1/18

(57) ABSTRACT

Provided is a steering column for a vehicle, the steering column including a tube housing coupled and fixed to a mounting bracket fixed to a vehicle body of a vehicle, a middle tube coupled to be slidable inside the tube housing and configured to move in an axial direction, an inner tube having an inner side to which a steering shaft is rotatably coupled, and an outer side to which the middle tube is slidably coupled, the inner tube being configured to move in the axial direction, a housing stopper coupled to the tube housing, and an inner stopper coupled to the inner tube and configured to move in the axial direction together with the inner tube and be supported on the housing stopper during collapse.

### CROSS-REFERENCE TO RELATED APPLICATIONS

This application claims the priority of Korean Patent Application No. 10-2025-0064003 filed on May 16, 2025, in the Korean Intellectual Property Office, the disclosure of which is incorporated herein by reference.

### BACKGROUND

### Field

The present embodiments relate to a steering column for a vehicle, and more particularly, to a steering column for a vehicle that may perform a telescopic motion of adjusting an axial length of the steering column and a stowing motion of retracting a steering wheel into a dashboard or extending the steering wheel outward.

### Description of the Related Art

In general, a steering column for a vehicle includes telescopic and tilting functions. With these functions, a driver may adjust a degree to which a steering wheel protrudes and an inclination angle of the steering wheel suitable for the driver's height or body type, thereby smoothly performing a steering operation.

Recently, a steer-by-wire steering apparatus, which excludes connection components that mechanically connect components, such as a shaft, a universal joint, or a pinion shaft, between the steering wheel and wheels and uses an electric motor, such as a motor, to steer the vehicle, has been developed and applied.

Further, with the development of the steer-by-wire steering apparatus, a steering column has been developed which enables autonomous driving that allows the driver to autonomously reach the destination without manipulating the steering wheel, an accelerator pedal, a brake, and the like. Further, there is a need to ensure a larger space to provide convenience for the driver seated in a driver seat during autonomous driving.

To this end, research has been conducted on increasing telescopic retraction and extension distances of a steering shaft or increasing a stowing distance by which the steering wheel is retracted into a dashboard or extended outward.

However, when the retraction and extension distances of the steering column for a vehicle increase, retraction and extension speeds also increase, and rebound of an inner tube or a middle tube occurs when collapse of a steering column is implemented in the event of a vehicle collision, which causes a problem in that sufficient stability and convenience for the driver cannot be ensured.

Accordingly, there is a need for research on a steering column for a vehicle that may increase the retraction and extension distances of the steering column for a vehicle, quickly and stably perform an operation when the collapse of the steering column is implemented in the event of a vehicle collision, and ensure both safety and convenience for the driver.

### SUMMARY

The present embodiments have been made in view of the above-mentioned background, and the present embodiments relate to a steering column for a vehicle that may more quickly and stably perform a telescopic motion of adjusting an axial length of the steering column for a vehicle and a stowing motion of retracting a steering wheel into a dashboard or extending the steering wheel outward.

In addition, the present embodiments relate to a steering column for a vehicle that may prevent rebound of an inner tube or a middle tube when collapse of the steering column is implemented in the event of a vehicle collision, thereby performing stable retraction and extension operations and providing sufficient stability and convenience for a driver.

The present embodiments may provide a steering column for a vehicle, the steering column including: a tube housing coupled to a mounting bracket and fixed to a vehicle body of a vehicle; a middle tube coupled to be slidable inside the tube housing and configured to move in an axial direction; an inner tube having an inner side to which a steering shaft is rotatably coupled, and an outer side to which the middle tube is slidably coupled, the inner tube being configured to move in the axial direction; a housing stopper coupled to the tube housing; and an inner stopper coupled to the inner tube and configured to move in the axial direction together with the inner tube and be supported on the housing stopper during collapse.

In the present embodiments, the middle tube may be provided with a guide hole formed by cutting the middle tube from an inner peripheral surface to an outer peripheral surface of the middle tube, and the inner stopper may be inserted into the guide hole.

In the present embodiments, the middle tube may be provided with guide holes formed by cutting the middle tube from an inner peripheral surface to an outer peripheral surface of the middle tube, the inner stopper may be inserted into the guide hole, and the guide holes may be provided as a pair of guide holes provided at positions that face each other in a radial direction.

In the present embodiments, the inner stopper and the housing stopper may be mounted at positions that respectively face the guide holes.

In the present embodiments, the tube housing may be provided with an insertion hole into which the housing stopper is inserted.

In the present embodiments, the tube housing may be provided with fixing holes provided at two opposite sides of the insertion hole, and fixing members configured to fix the housing stopper may be coupled to the fixing holes.

In the present embodiments, fixing protrusions may protrude from an outer peripheral surface of the tube housing, and the fixing holes may be provided in the fixing protrusions.

In the present embodiments, the housing stopper may include: a stopper support portion coupled to the insertion hole and supported on the inner stopper; and a housing support portion extending from an end of the stopper support portion and provided with coupling holes provided at positions facing the fixing holes so that the fixing members are coupled to the coupling holes.

In the present embodiments, the insertion hole and the stopper support portion may be elongated in a circumferential direction of the tube housing.

In the present embodiments, the inner tube may be provided with a coupling groove to which the inner stopper is coupled.

In the present embodiments, the inner stopper may include: an elastic member inserted into the coupling groove and configured to be elastically deformed in the radial direction; and a support member elastically supported on the elastic member and supported on an inner peripheral surface of the tube housing.

In the present embodiments, the support member may be formed in a spherical shape.

In the present embodiments, the support member may move in the axial direction together with the inner tube and be inserted into the insertion hole of the tube housing during the collapse.

In the present embodiments, a half or more of an outer peripheral surface of the support member may be inserted and supported into the insertion hole.

In the present embodiments, the support member may be inserted into the insertion hole, and an end of the support member may be supported on the housing stopper.

In the present embodiments, the inner stopper may further include an insertion member configured to accommodate the elastic member and coupled to the coupling groove.

According to the present embodiments described above, it is possible to more quickly and stably perform the telescopic motion of adjusting the axial length of the steering column for a vehicle and the stowing motion of retracting the steering wheel into the dashboard or extending the steering wheel outward.

In addition, according to the present embodiments, it is possible to prevent rebound of the inner tube or the middle tube when collapse of the steering column is implemented in the event of a vehicle collision, thereby performing stable retraction and extension operations and providing sufficient stability and convenience for the driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view of a steering column for a vehicle according to the present embodiments;

FIG. 2 is an exploded perspective view of a part of the steering column for a vehicle according to the present embodiments;

FIG. 3 is a perspective view of a part of the steering column for a vehicle according to the present embodiments;

FIG. 4 is a cross-sectional view of the steering column for a vehicle according to the present embodiments;

FIG. 5 is an exploded perspective view of a part of the steering column for a vehicle according to the present embodiments;

FIG. 6 is a cross-sectional view illustrating a state made before collapse of the steering column for a vehicle according to the present embodiments;

FIG. 7 is an enlarged view of part A in FIG. 6;

FIG. 8 is an enlarged view of part B in FIG. 6;

FIG. 9 is a cross-sectional view illustrating a state made after collapse of the steering column for a vehicle according to the present embodiments; and

FIG. 10 is an enlarged view of part C in FIG. 9.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

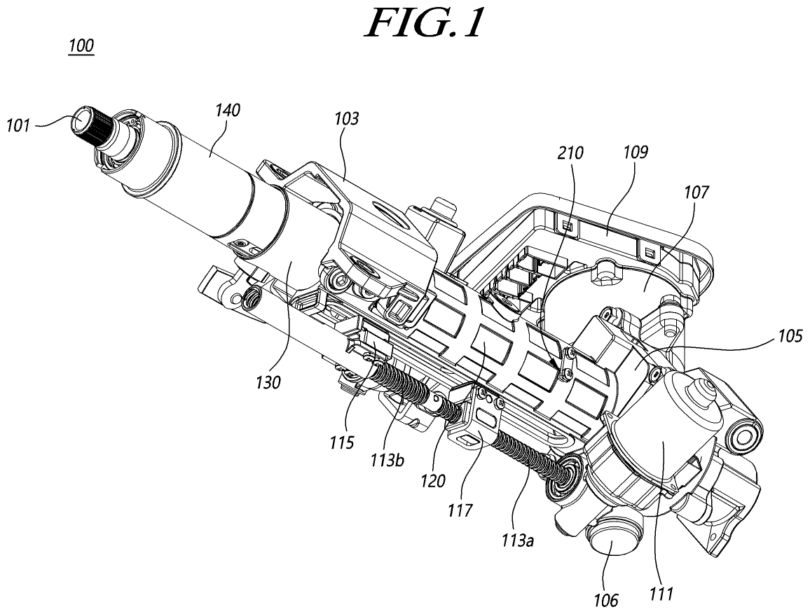

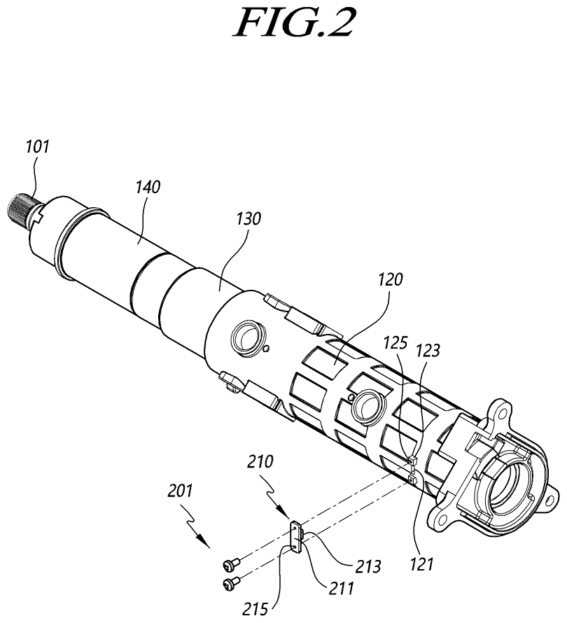

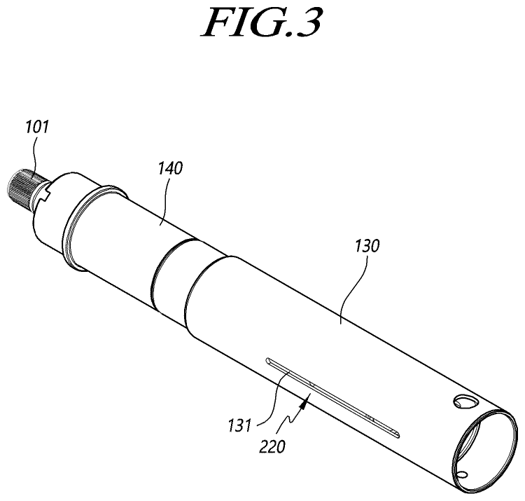

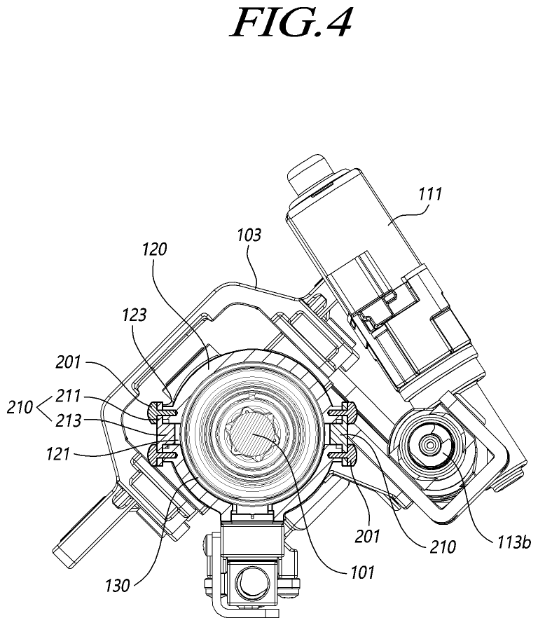

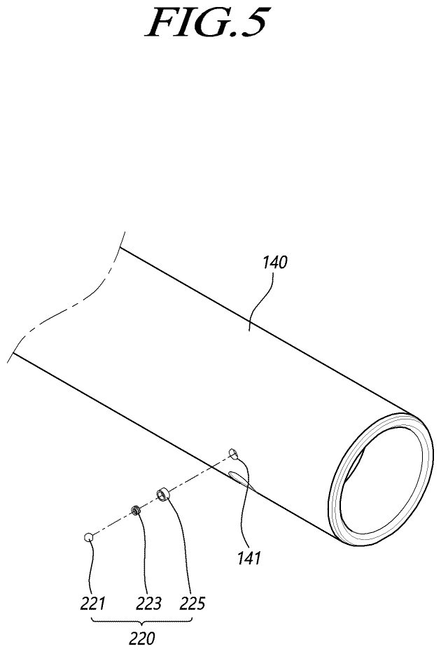

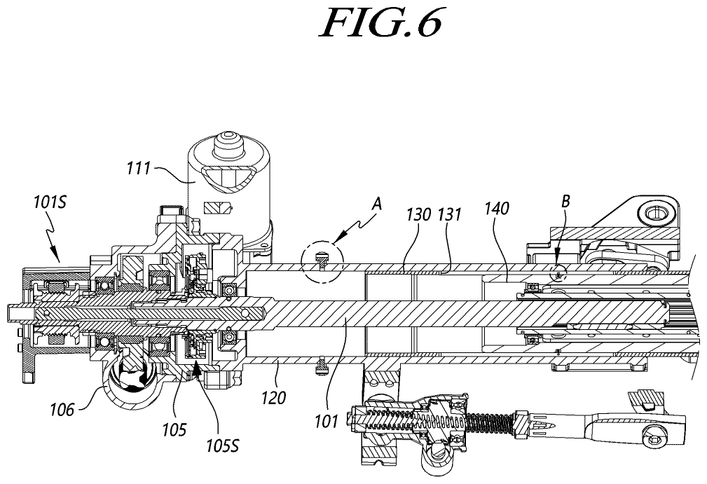

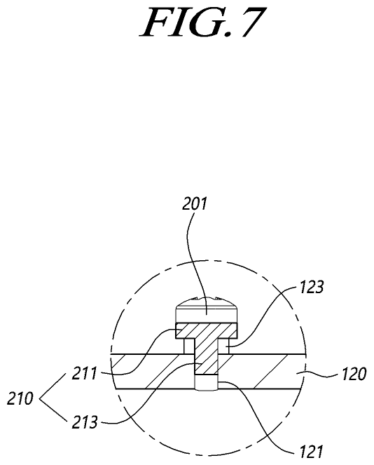

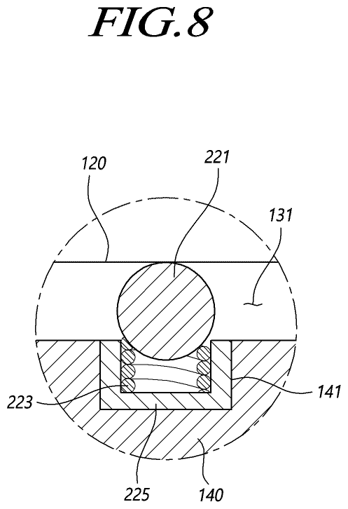

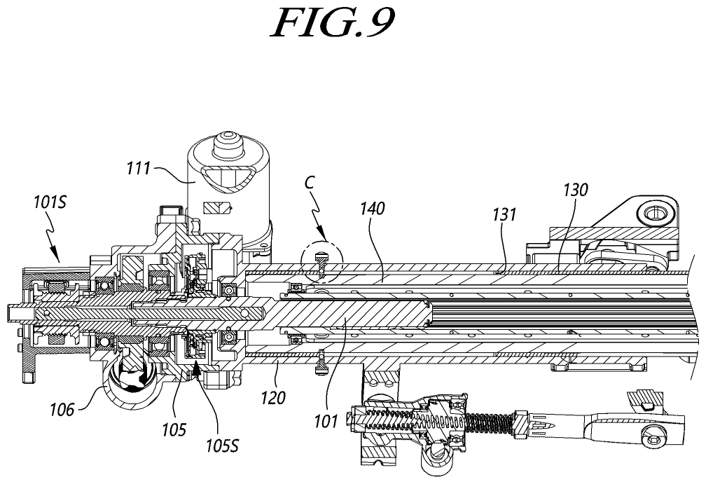

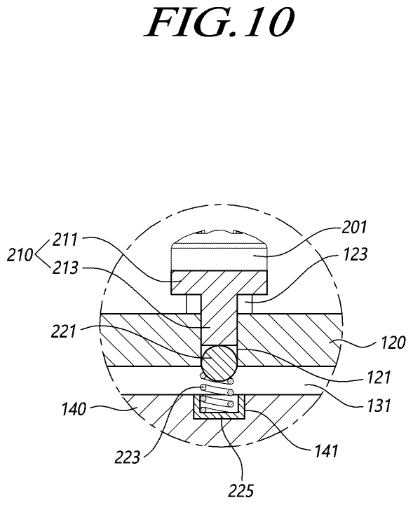

FIG. 1 is a perspective view of a steering column for a vehicle according to the present embodiments, FIG. 2 is an exploded perspective view of a part of the steering column for a vehicle according to the present embodiments, FIG. 3 is a perspective view of a part of the steering column for a vehicle according to the present embodiments, FIG. 4 is a cross-sectional view of the steering column for a vehicle according to the present embodiments, FIG. 5 is an exploded perspective view of a part of the steering column for a vehicle according to the present embodiments, FIG. 6 is a cross-sectional view illustrating a state made before collapse of the steering column for a vehicle according to the present embodiments, FIG. 7 is an enlarged view of part A in FIG. 6, FIG. 8 is an enlarged view of part B in FIG. 6, FIG. 9 is a cross-sectional view illustrating a state made after collapse of the steering column for a vehicle according to the present embodiments, and FIG. 10 is an enlarged view of part C in FIG. 9.

In the following detailed description of the present embodiments with reference to FIGS. 1 to 10, an upward direction refers to a direction directed toward a steering wheel, and a downward direction refers to a direction opposite to the upward direction. Further, the description will be described on the assumption that among operations including retraction and extension, a retraction operation and a collapse operation refer to operations of moving the steering wheel downward so that an axial length of a steering column 100 decreases, and an extension operation and a rebound operation refer to operations of moving the steering wheel upward so that the axial length of the steering column 100 increases.

The steering column 100 for a vehicle according to the present embodiments includes a tube housing 120 coupled to a mounting bracket 103 and fixed to a vehicle body of a vehicle, a middle tube 130 coupled to be slidable inside the tube housing 120 and configured to move in an axial direction, an inner tube 140 having an inner side to which a steering shaft 101 is rotatably coupled, and an outer side to which the middle tube 130 is slidably coupled, the inner tube 140 being configured to move in the axial direction, a housing stopper 210 coupled to the tube housing 120, an inner stopper 220 coupled to the inner tube 140 and configured to move in the axial direction together with the inner tube 140 and be supported on the housing stopper 210 during collapse.

The mounting bracket 103 is provided with a fixing flange and a fixing hole so that the mounting bracket 103 is fixed to the vehicle body of the vehicle. Therefore, the steering column 100 is fixed to the vehicle body of the vehicle, and a steering wheel (not illustrated) is coupled to a leading end of the steering shaft 101, such that a steering manipulation is performed by a driver.

In the steering column 100 according to the present embodiments, the middle tube 130 is slidably coupled to the tube housing 120, such that retraction and extension motions are performed in the axial direction.

Further, the inner tube 140, which has the inner side to which the steering shaft 101 is rotatably coupled, is inserted into the middle tube 130, such that the retraction and extension motions are performed in the axial direction.

In the present embodiments, the retraction and extension motions include a telescopic motion of adjusting a length of the steering column 100 and a stowing motion of retracting the steering wheel into a dashboard or extending the steering wheel outward. The retraction and extension motions broadly include a collapse operation of the steering column 100 that occurs in the direction of a vehicle collision.

A motor 111 provided at a lower end of the tube housing 120 rotates a first screw 113a and a second screw 113b, and a first nut 117, which is coupled to the first screw 113a, and a second nut 115, which is coupled to the second screw 113b, slide the middle tube 130 and the inner tube 140 in the axial direction.

The axial retraction and extension motions of the tube housing 120, the middle tube 130, and the inner tube 140 include the telescopic motion or the stowing motion performed by the driver.

A lower end of the tube housing 120 is coupled to a sensor housing 105 embedded with a torque angle sensor 105s, and a speed reducer housing 106 is coupled to the sensor housing 105 and configured to reduce driving power of the motor 111 by using a worm and a worm wheel.

As illustrated in FIG. 3, the middle tube 130, which is slidably coupled to the inner side of the tube housing 120, is provided with guide holes 131 formed by cutting the middle tube 130 from an inner peripheral surface to an outer peripheral surface of the middle tube 130. The inner stopper 220 is inserted into the guide hole 131.

The guide hole 131 is elongated in the axial direction of the steering column. The guide holes 131 may be provided as a pair of guide holes 131 provided at positions that face each other in a radial direction.

Further, the inner stopper 220 and the housing stopper 210 may be mounted at positions that respectively face the guide holes 131.

Therefore, during the collapse, a load of the inner stopper 220 supported on the housing stopper 210 may be uniformly supported without being biased toward any one side.

As illustrated in FIG. 2, the tube housing 120, which is coupled and fixed to the mounting bracket 103, is provided with an insertion hole 121 into which the housing stopper 210 is inserted.

Therefore, during the collapse of the steering column occurring in the event of a vehicle collision, the inner stopper 220 may move in the axial direction and then be inserted into the insertion hole 121, and the inner stopper 220 may be supported on the insertion hole 121 and the housing stopper 210.

In addition, the tube housing 120 may be provided with fixing holes 125 provided at two opposite sides of the insertion hole 121, and fixing members 201 configured to fix the housing stopper 210 may be coupled to the fixing holes 125.

Further, fixing protrusions 123 may protrude from an outer peripheral surface of the tube housing 120, and the fixing holes 125 are provided in the fixing protrusions 123, such that the housing stopper 210 may be coupled by means of the fixing members 201 through communication holes 215 and the fixing holes 125 while being supported by the fixing member 201.

Therefore, the housing stopper 210 may be more securely fixed to the tube housing 120, thereby enhancing rigidity of a periphery of the tube housing 120 to which the housing stopper 210 is coupled.

The housing stopper 210 may include a stopper support portion 213 coupled to the insertion hole 121 and supported on the inner stopper 220, and a housing support portion 211 extending from an end of the stopper support portion 213 and provided with the communication holes 215 provided at the positions facing the fixing holes 125 so that the fixing members 201 are coupled to the communication holes 215.

The insertion hole 121 and the stopper support portion 213 may be elongated in a circumferential direction of the tube housing 120. Because the insertion hole 121 and the stopper support portion 213 are elongated in the circumferential direction as described above, the inner stopper 220 may be inserted into the insertion hole 121 and supported on the housing stopper 210 even though the middle tube 130 and the inner tube 140 rotate during the collapse.

The inner tube 140 may be provided with a coupling groove 141 to which the inner stopper 220 is coupled. However, the present disclosure is not necessarily limited thereto. The inner stopper 220 may be attached to an outer peripheral surface of the inner tube 140 or fixed by the separate fixing member 201.

As illustrated in FIGS. 5 and 8, the inner stopper 220 may include an elastic member 223 inserted into the coupling groove 141 and configured to be elastically deformed in the radial direction, and a support member 221 elastically supported by the elastic member 223 and supported on an inner peripheral surface of the tube housing 120.

The support member 221 may be formed in a spherical shape.

As illustrated in FIG. 8, during the collapse occurring in the event of a vehicle collision, the support member 221, which is positioned in the guide hole 131, moves together with the inner tube 140 in the axial direction along the guide hole 131.

Further, when the collapse is completed, the support member 221 is inserted into the insertion hole 121 of the tube housing 120, as illustrated in FIG. 10.

In this case, a half or more of an outer peripheral surface of the support member 221 may be inserted into the insertion hole 121 and supported by the housing stopper 210 and the insertion hole 121, thereby restraining rebound in a direction opposite to a collapse direction.

As illustrated in FIG. 10, when the collapse is completed, the support member 221 is inserted into the insertion hole 121, and an end of the support member 221 is supported on the housing stopper 210, such that the radial separation thereof may be restricted, and a supporting force between the support member 221 and the tube housing 120 may be maintained, thereby preventing rebound of the middle tube 130 and the inner tube 140.

The inner stopper 220 may further include an insertion member 225 configured to accommodate the elastic member 223 and coupled to the coupling groove 141, and the insertion member 225 may be formed in a cylindrical shape or a cylindrical shape closed at one end thereof.

FIGS. 5 and 10 illustrate an example in which the insertion member 225 is formed in a cylindrical shape closed at one end thereof.

Because the insertion member 225 is provided as described above, the elastic member 223 and the support member 221 are easily assembled to the inner tube 140.

The steering column for a vehicle according to the present embodiments described above may not only be applied to a general steering column for a vehicle, which allows the driver to steer the vehicle, but also be applied to a steering column for a vehicle that enables autonomous driving.

In particular, with reference to a steer-by-wire steering apparatus that enables autonomous driving, the torque angle sensor 105s, which detects a manipulation of the steering wheel by the driver, transmits an electrical signal to an electronic control device 109, such that a steering wheel motor 107 and a pinion shaft motor (not illustrated) are operated.

The electronic control device 109 controls the steering wheel motor 107 and the pinion shaft motor based on the electrical signal transmitted from the torque angle sensor 105s and electrical signals transmitted from several sensors mounted in the vehicle.

The steering wheel motor 107 is connected to the speed reducer housing 106 configured to reduce a rotational speed of the motor. During normal traveling, the steering wheel motor 107 provides a reaction force to the steering wheel so that the driver may perceive a steering reaction force in an opposite direction when the driver manipulates the steering wheel. During autonomous driving, the steering is performed under the control of the electronic control device 109 without intervention of the driver's intention.

Further, in the steer-by-wire steering apparatus, a rotation angle restriction member 101s configured to restrict a rotation angle of the steering shaft 101 is provided at a lower end of the speed reducer housing 106.

According to the present embodiments described above, it is possible to more quickly and stably perform the telescopic motion of adjusting the axial length of the steering column for a vehicle and the stowing motion of retracting the steering wheel into the dashboard or extending the steering wheel outward.

In addition, according to the present embodiments, it is possible to prevent rebound of the inner tube or the middle tube when collapse of the steering column is implemented in the event of a vehicle collision, thereby performing stable retraction and extension operations and providing sufficient stability and convenience for the driver.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A steering column for a vehicle, the steering column comprising:
a tube housing coupled to a mounting bracket and fixed to a vehicle body of a vehicle;
a middle tube coupled to be slidable inside the tube housing and configured to move in an axial direction;
an inner tube having an inner side to which a steering shaft is rotatably coupled, and an outer side to which the middle tube is slidably coupled, the inner tube being configured to move in the axial direction;
a housing stopper coupled to the tube housing; and
an inner stopper coupled to the inner tube and configured to move in the axial direction together with the inner tube and be supported on the housing stopper during collapse.

2. The steering column of claim 1, wherein the middle tube is provided with a guide hole formed by cutting the middle tube from an inner peripheral surface to an outer peripheral surface of the middle tube, and the inner stopper is inserted into the guide hole.

3. The steering column of claim 1, wherein the middle tube is provided with guide holes formed by cutting the middle tube from an inner peripheral surface to an outer peripheral surface of the middle tube, the inner stopper is inserted into the guide hole, and the guide holes are provided as a pair of guide holes provided at positions that face each other in a radial direction.

4. The steering column of claim 3, wherein the inner stopper and the housing stopper are mounted at positions that respectively face the guide holes.

5. The steering column of claim 4, wherein the tube housing is provided with an insertion hole into which the housing stopper is inserted.

6. The steering column of claim 5, wherein the tube housing is provided with fixing holes provided at two opposite sides of the insertion hole, and fixing members configured to fix the housing stopper are coupled to the fixing holes.

7. The steering column of claim 6, wherein fixing protrusions protrude from an outer peripheral surface of the tube housing, and the fixing holes are provided in the fixing protrusions.

8. The steering column of claim 7, wherein the housing stopper comprises:
a stopper support portion coupled to the insertion hole and supported on the inner stopper; and
a housing support portion extending from an end of the stopper support portion and provided with communication holes provided at positions facing the fixing holes so that the fixing members are coupled to the communication holes.

9. The steering column of claim 8, wherein the insertion hole and the stopper support portion are elongated in a circumferential direction of the tube housing.

10. The steering column of claim 5, wherein the inner tube is provided with a coupling groove to which the inner stopper is coupled.

11. The steering column of claim 10, wherein the inner stopper comprises:
an elastic member inserted into the coupling groove and configured to be elastically deformed in the radial direction; and
a support member elastically supported on the elastic member and supported on an inner peripheral surface of the tube housing.

12. The steering column of claim 11, wherein the support member is formed in a spherical shape.

13. The steering column of claim 12, wherein the support member moves in the axial direction together with the inner tube and is inserted into the insertion hole of the tube housing during the collapse.

14. The steering column of claim 13, wherein a half or more of an outer peripheral surface of the support member is inserted and supported into the insertion hole.

15. The steering column of claim 14, wherein the support member is inserted into the insertion hole, and an end of the support member is supported on the housing stopper.

16. The steering column of claim 11, wherein the inner stopper further comprises an insertion member configured to accommodate the elastic member and coupled to the coupling groove.
